(19) United States
(12) Patent Application Publication
(10) Pub. No.: US 2026/0072289 A1
(43) Pub. Date: Mar. 12, 2026

(54) MULTIBAND DICHROIC METAMIRROR AND METHOD

(71) Applicant: Raytheon Company, Tewksbury, MA (US)

(72) Inventors: Andrew C. McClung, Florence, MA (US); Urcan Guler, Avon, CT (US)

(21) Appl. No.: 18/827,307

(22) Filed: Sep. 6, 2024

(51) Int. Cl. G02B 27/10; G02B 1/00; G02B 5/08; G02B 5/18; G02B 27/14

(52) U.S. Cl. CPC G02B 27/1006; G02B 1/002; G02B 5/0833; G02B 5/1814; G02B 5/1857; G02B 27/1086; G02B 27/141

(57) ABSTRACT

A multiband dichroic metamirror includes a dielectric mirror and a metasurface. The dielectric mirror is configured to split incident light into a first waveband and a second waveband. The dielectric mirror is also configured to transmit the first waveband with a high transmission value and to reflect the second waveband with a high reflection value. The metasurface acts as a diffractive optical element that is configured to provide optical power for the second waveband.

### TECHNICAL FIELD

This disclosure relates generally to optical devices. More specifically, this disclosure relates to a multiband dichroic metamirror and method.

### BACKGROUND

Conventional dichroics provide the ability to split incoming light into multiple wavebands. However, conventional dichroics are flat and do not provide any focusing power for the wavebands. While focusing power can be provided by adding a coating to the surface of a dichroic that has a curved surface, this technique introduces imaging complications that need to be addressed downstream of the dichroic.

### SUMMARY

This disclosure relates to a multiband dichroic metamirror and method.

In a first embodiment, a multiband dichroic metamirror includes a dielectric mirror and a metasurface. The dielectric mirror is configured to split incident light into a first waveband and a second waveband. The dielectric mirror is also configured to transmit the first waveband with a high transmission value and to reflect the second waveband with a high reflection value. The metasurface acts as a diffractive optical element that is configured to provide optical power for the second waveband.

Any single one or any combination of the following features may be used with the first embodiment. The first waveband may include a Mid-Wave Infrared (MWIR) band, and the second waveband may include a Short-Wave Infrared (SWIR) band. The metasurface may include a plurality of metaatoms and may be configured to provide optical power for the second waveband by introducing an interference effect through an arrangement of the metaatoms. At least a portion of the metaatoms may include non-identical shapes with respect to each other. The arrangement of the metaatoms may be configured to implement a spatially varying phase delay between 0 and 2π for wavelengths associated with the second waveband. The optical power may implement a focusing function or aberration correction. The dielectric mirror, which may be a flat dichroic, may include a substrate and a plurality of dielectric layers. The substrate may include one of sapphire, zinc selenide, zinc sulfide, calcium fluoride or barium fluoride. The dielectric layers may include alternating thin films of titanium dioxide and silicon dioxide. The metasurface may comprise metaatoms with heights of about 525 nm and a lattice constant of about 625 nm. The dielectric mirror may include a plurality of dielectric layers of alternating thin films of dielectric materials, and each of the dielectric materials may have an index of refraction between 1.3 and 4.0.

In a second embodiment, an optical device includes an aperture, a multiband dichroic metamirror, and a second waveband image device. The aperture is configured to receive incident light. The multiband dichroic metamirror is configured to split the incident light into a first waveband and a second waveband. The multiband dichroic metamirror is also configured to transmit the first waveband with a high transmission value. The multiband dichroic metamirror is further configured to reflect the second waveband with a high reflection value and to provide optical power for the second waveband. In addition, the multiband dichroic metamirror is configured to direct the reflected second waveband towards the second waveband image device.

Any single one or any combination of the following features may be used with the second embodiment. The multiband dichroic metamirror may include a dielectric mirror and a metasurface coupled to the dielectric mirror. The metasurface may act as a diffractive optical element configured to provide optical power for the second waveband. The metasurface may include a plurality of metaatoms and may be configured to provide optical power for the second waveband by introducing an interference effect through an arrangement of the metaatoms. At least a portion of the metaatoms may include non-identical shapes with respect to each other. The arrangement of the metaatoms may be configured to implement a spatially varying phase delay between 0 and 2π for wavelengths associated with the second waveband. The dielectric mirror, which may be a flat dichroic, may include a substrate and a plurality of dielectric layers. The substrate may include one of sapphire, zinc selenide, zinc sulfide, calcium fluoride or barium fluoride. The dielectric layers may include alternating thin films of titanium dioxide and silicon dioxide. The metasurface may comprise metaatoms with heights of about 525 nm and a lattice constant of about 625 nm. The dielectric mirror may include a plurality of dielectric layers of alternating thin films of dielectric materials, and each of the dielectric materials may have an index of refraction between 1.3 and 4.0. The first waveband may include a MWIR band, and the second waveband may include a SWIR band. The optical power may implement a focusing function or an aberration correction. The second waveband image device may include at least one of a sensor, a transmitter, and a focal plane. The optical device may include first waveband optics. The multiband dichroic metamirror may be configured to transmit the first waveband to the first waveband optics. The first waveband optics may include at least one lens and a focal plane.

In a third embodiment, a method includes depositing a metasurface material over a dielectric mirror. The dielectric mirror is configured to split incident light into a first waveband and a second waveband. The dielectric mirror is also configured to transmit the first waveband with a high transmission value and to reflect the second waveband with a high reflection value. The method also includes patterning and etching the metasurface material to create a metasurface that is configured to provide optical power for the second waveband.

Any single one or any combination of the following features may be used with the third embodiment. Patterning and etching the metasurface material to create the metasurface may include creating a plurality of metaatoms. At least a portion of the metaatoms can have non-identical shapes with respect to each other. Patterning and etching the metasurface material to create the metasurface may include arranging the plurality of metaatoms to implement a spatially varying phase delay between 0 and 2π for wavelengths associated with the second waveband.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example of an optical device including a multiband dichroic metamirror according to this disclosure;

FIG. 2A illustrates an example of details of a portion of the optical device of FIG. 1 according to this disclosure;

FIG. 2B illustrates another example of details of a portion of the optical device of FIG. 1 according to this disclosure;

FIG. 3 illustrates an example of details of the multiband dichroic metamirror of FIGS. 1, 2A, or 2B according to this disclosure; and

FIG. 4 illustrates an example of a method for manufacturing a multiband dichroic metamirror according to this disclosure.

### DETAILED DESCRIPTION

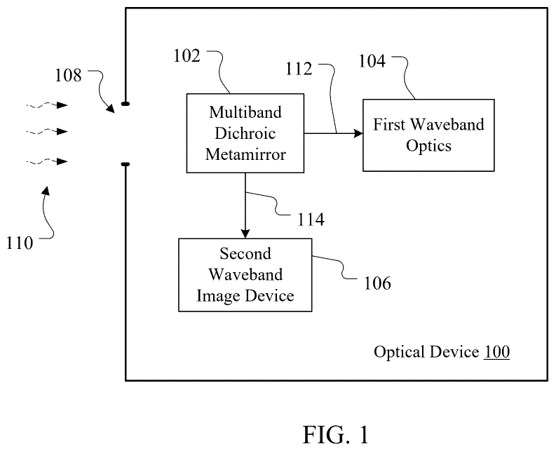

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, conventional dichroics provide the ability to split incoming light into multiple wavebands. However, conventional dichroics are flat and do not provide any focusing power for the wavebands. Thus, flat dichroics are not useful for applications in which focusing the light without including lenses is necessary or desirable. As an alternative to a flat dichroic, focusing power can be provided by adding a coating to the surface of a dichroic that has a curved surface. However, this technique introduces imaging complications that need to be addressed downstream of the dichroic.

This disclosure provides a multiband dichroic metamirror and method. As described in more detail below, a multiband dichroic metamirror (which may be flat) can include a dielectric mirror and a metasurface. The dielectric mirror can split incident light into a first waveband and a second waveband, transmit the first waveband with a high transmission value, and reflect the second waveband with a high reflection value. The metasurface can act as a diffractive optical element that may provide optical power for the second waveband. In some cases, the metasurface may introduce an interference effect, which can result in a variable phase shift for the second waveband reflected from the dichroic. The variable phase shift may allow the second waveband to be focused or otherwise optically altered. In this way, the multiband dichroic metamirror can split multiple wavebands into different paths while also focusing or otherwise optically modifying one of the wavebands. As a result, optical power can be provided without the need for coating a curved surface, which can avoid the introduction of imaging complications that arise from a curved-surface dichroic.

FIG. 1 illustrates an example of an optical device 100 including a multiband dichroic metamirror 102 according to this disclosure. The embodiment of the optical device 100 shown in FIG. 1 is for illustration only. Other embodiments of the optical device 100 may be used without departing from the scope of this disclosure.

According to embodiments of this disclosure, in addition to the multiband dichroic metamirror 102, the optical device 100 may include first waveband optics 104 and a second waveband image device 106. The optical device 100 may also include an aperture 108 through which incident light 110 may pass for processing by the optical device 100. The optical device 100 may include a camera, a laser rangefinder and target designator, a machine vision device, a laser welding device, a laser machining device, or any other suitable device in which it is desirable to split incident light 110 into multiple wavebands.

In the illustrated embodiment, the multiband dichroic metamirror 102 is configured to split the incident light 110 into two wavebands, namely a first waveband 112 and a second waveband 114. In some embodiments, the first waveband 112 may include emissive infrared in the form of a Mid-Wave Infrared (MWIR) band, and the second waveband 114 may include reflective infrared in the form of a Short-Wave Infrared (SWIR) band. However, it will be understood that each of the wavebands 112 and 114 may include any other suitable wavelength(s). Note that this approach allows for multiple wavebands to be received through a common aperture 108.

The multiband dichroic metamirror 102 is configured to receive the incident light 110 through the aperture 108 of the optical device 100 and to transmit the first waveband 112 of the incident light 110 with a high transmission value. As used herein, transmitting with a “high transmission value” means that the waveband is transmitted with high diffraction efficiency in the transmitted zero order. For example, in some embodiments, the multiband dichroic metamirror 102 may be configured to transmit the first waveband 112 with transmitted zero order diffraction efficiencies of at least 75%, 80%, 83%, or other suitable high diffraction efficiency. Thus, the multiband dichroic metamirror 102 is configured to split the first waveband 112 from the incident light 110 and to transmit the first waveband 112 to the first waveband optics 104 with a high transmission value. The first waveband optics 104 are configured to process the first waveband 112. For example, in some embodiments, the first waveband optics 104 may include one or more lenses and/or a focal plane on which to produce an image based on the first waveband 112.

The multiband dichroic metamirror 102 is also configured to reflect the second waveband 114 of the incident light 110 received through the aperture 108 with a high reflection value and to provide optical power for the reflected second waveband 114. As used herein, reflecting with a “high reflection value” means that the waveband is reflected with high diffraction efficiency in a desired, nonzero order. For example, in some embodiments, the multiband dichroic metamirror 102 may be configured to reflect the second waveband 114 with diffraction efficiencies in the desired order of at least 98%, 99%, 99.5%, or other suitable high diffraction efficiency. Thus, in some embodiments, the multiband dichroic metamirror 102 may be configured to split the second waveband 114 from the incident light 110 and to reflect and focus the second waveband 114 towards the second waveband image device 106. In other embodiments, the multiband dichroic metamirror 102 may be configured to split the second waveband 114 from the incident light 110 and to reflect and provide optical power for the second waveband 114 other than focusing before providing the reflected second waveband 114 to the second waveband image device 106. For example, in some embodiments, instead of or in addition to focusing, the multiband dichroic metamirror 102 may be configured to provide aberration correction or other suitable optical function for the second waveband 114.

In some embodiments, the second waveband image device 106 may include a sensor that is configured to sense the second waveband 114 and to send a signal based on sensing the second waveband 114 to another component of the optical device 100 or another separate device for further processing. In other embodiments, the second waveband image device 106 may include a transmitter that is configured to transmit the second waveband 114 to the multiband dichroic metamirror 102 for projection into an object space of a system in which the optical device 100 is implemented. In still other embodiments, the second waveband image device 106 may include a focal plane on which an image may be formed based on focusing of the second waveband 114.

In particular embodiments, the optical device 100 may include a range finding capability. In these embodiments, the optical device 100 may be configured to generate a laser signal aimed at a particular object and receive a reflected laser signal as part of the incident light 110 due to the laser signal bouncing off that particular object. Based on the reflected laser signal in the incident light 110, the optical device 100 may be configured to determine a distance from the optical device 100 to the particular object. In addition, for this embodiment, the focused second waveband 114 may include an image of the particular object. This image can be formed on, sensed by, and/or transmitted by the second waveband image device 106. For example, the second waveband image device 106 may be configured to transmit the image to another device or another component of the optical device 100 for processing and/or display.

Although FIG. 1 illustrates one example of an optical device 100 including a multiband dichroic metamirror 102, various changes may be made to FIG. 1. For instance, the optical device 100 may include additional components not shown in FIG. 1. For example, the optical device 100 may include one or more components for generating a laser signal and determining a distance to an object based on a reflected laser signal. Also, the optical device 100 may include one or more components for displaying an image included in the focused second waveband 114. In addition, the direction in which the second waveband 114 is reflected from the multiband dichroic metamirror 102 may be any suitable direction and need not be perpendicular to the incident light 110 or the first waveband 112 as illustrated. Finally, note that the view shown in FIG. 1 is not to scale.

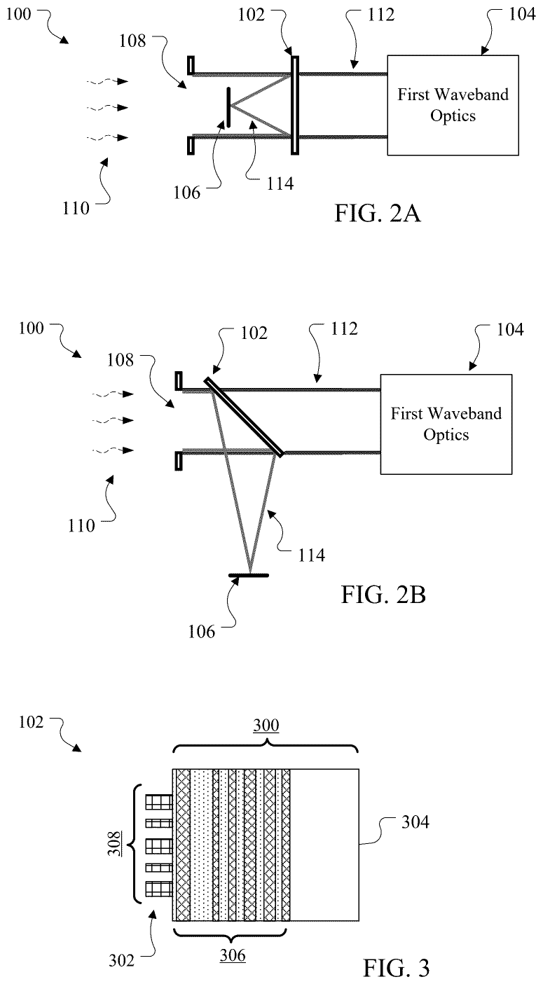

FIGS. 2A and 2B illustrate examples of details of a portion of the optical device 100 according to this disclosure. The portion of the optical device 100 shown in FIGS. 2A-2B is for illustration only. Other embodiments of the optical device 100 may be used without departing from the scope of this disclosure.

In the embodiments illustrated in FIGS. 2A and 2B, the multiband dichroic metamirror 102 receives incident light 110 through the aperture 108 and splits the incident light 110 into the first waveband 112 and the second waveband 114. The multiband dichroic metamirror 102 transmits the first waveband 112 with a high transmission value to the first waveband optics 104. Thus, the first waveband 112 is transmitted substantially unchanged with high diffraction efficiencies. The first waveband optics 104 process the first waveband 112 in any suitable manner. For example, in some embodiments, the first waveband optics 104 may focus the first waveband 112 using one or more lenses and produce an image based on the first waveband 112 on a focal plane.

In some embodiments, the multiband dichroic metamirror 102 reflects the second waveband 114 with a high reflection value and focuses the reflected second waveband 114 towards the second waveband image device 106. Thus, the second waveband 114 is reflected with a high diffraction efficiency before being focused towards the second waveband image device 106. In other embodiments, the multiband dichroic metamirror 102 reflects the second waveband 114 with a high reflection value and provides another optical power function for the reflected second waveband 114, such as aberration correction or the like, before providing the optically altered second waveband 114 to the second waveband image device 106.

In some embodiments, the second waveband image device 106 senses the second waveband 114 and sends a signal based on sensing the second waveband 114 to another component of the optical device 100 or another separate device for further processing. In other embodiments, the second waveband image device 106 transmits the second waveband 114 to the multiband dichroic metamirror 102 for projection into the object space of the system in which the optical device 100 is implemented. In still other embodiments, the second waveband image device 106 provides a focal plane on which an image based on the second waveband 114 is formed.

In the embodiment illustrated in FIG. 2A, the second waveband image device 106 is located within the path of the incident light 110, between the aperture 108 and the multiband dichroic metamirror 102, by positioning the multiband dichroic metamirror 102 substantially perpendicular to the incident light 110. For the embodiment illustrated in FIG. 2B, the second waveband image device 106 is located outside the path of the incident light 110 by positioning the multiband dichroic metamirror 102 at an angle relative to the incident light 110 such that the multiband dichroic metamirror 102 is not substantially perpendicular to the incident light 110.

Although FIGS. 2A and 2B illustrate examples of details of a portion of the optical device 100, various changes may be made to FIGS. 2A and 2B. For instance, the optical device 100 may include additional components not shown in FIG. 2A or 2B. In addition, note that the views shown in FIGS. 2A and 2B are not to scale.

FIG. 3 illustrates an example of details of the multiband dichroic metamirror 102 of FIGS. 1, 2A, or 2B according to this disclosure. The embodiment of the multiband dichroic metamirror 102 shown in FIG. 3 is for illustration only. Other embodiments of the multiband dichroic metamirror 102 may be used without departing from the scope of this disclosure.

According to embodiments of this disclosure, the multiband dichroic metamirror 102 may include a dielectric mirror 300 and a metasurface 302. The dielectric mirror 300 may include a flat dichroic that includes a substrate 304 and a plurality of dielectric layers 306. In some embodiments in which the first waveband 112 includes MWIR, the substrate 304 may include sapphire, zinc selenide, zinc sulfide, calcium fluoride, barium fluoride, or other material(s) substantially transparent to the MWIR band. However, it will be understood that the substrate 304 may include any suitable material(s) substantially transparent to the first waveband 112, which is transmitted through the substrate 304 by the dielectric mirror 300.

The dielectric layers 306 may include alternating layers of two or more different dielectric materials. In some embodiments, for example, the dielectric layers 306 may include alternating thin films of titanium dioxide and silicon dioxide. However, it will be understood that the dielectric layers 306 may include any other suitable dielectric materials based on the application in which the multiband dichroic metamirror 102 is to be implemented. Note that the index of refraction for each of these dielectric materials may be between 1.3 and 4.0. The dielectric layers 306 may be deposited over the substrate 304 using an ion beam sputtering process or other any suitable deposition process or other process.

In some embodiments, a uniform layer of amorphous silicon or other suitable metasurface material may be deposited over the dielectric layers 306 of the dielectric mirror 300, such as by using plasma-enhanced chemical vapor deposition or other suitable deposition technique or other process. The metasurface material may be patterned, such as by using photolithography or other patterning process, and etched to create the metasurface 302. In this example, the metasurface 302 includes a plurality of metaatoms 308 within a uniform layer. In some embodiments, the uniform layer of the metasurface material may be about 525 nm thick such that the resulting metaatoms 308 may have a height of about 525 nm. In some embodiments, the resulting metaatoms 308 may have a lattice constant of about 625 nm.

According to embodiments of the disclosure, the metasurface 302 may act as a diffractive optical element. Thus, the metasurface 302 may be configured to introduce an interference effect through the arrangement of the metaatoms 308. To accomplish this, individual metaatoms 308 may be configured to implement different phase delays from each other, and the plurality of metaatoms 308 may be arranged in the metasurface 302 in such a way as to achieve a desired focusing function, aberration correction, or other optical function. This can result in a variable phase shift across the metasurface 302 for the second waveband 114 when the second waveband 114 passes through the metasurface 302 to reach the dielectric mirror 300 and again when the second waveband 114 passes back through the metasurface 302 after being reflected from the dielectric mirror 300. The variable phase shift can allow the second waveband 114 as reflected to be focused or otherwise optically altered. For example, as described above, the second waveband 114 may be focused towards the second waveband image device 106.

In some embodiments, the metaatoms 308 may be configured to implement at least a complete 0 to 2π phase shift for wavelengths associated with the second waveband 114. Thus, for embodiments in which the second waveband 114 includes SWIR, the metaatoms 308 may form the metasurface 302 such that the thickest and thinnest individual metaatoms 308 (which in some embodiments may include the absence of a metaatom 308) are configured to implement at least a 2π relative phase shift at wavelengths of about 1550nm.

As illustrated in FIG. 3, at least a portion of the metaatoms 308 may include non-identical shapes with respect to each other. Thus, for example, the metaatoms 308 may be rectangular in shape but may have individually varying widths. In other embodiments, the metaatoms 308 may include other suitable shapes but may have individually varying sizes and/or shapes. As described above, in some embodiments, the heights of the metaatoms 308 may be about 525 nm. However, it will be understood that the heights of the metaatoms 308 may be based on any suitable value that can provide at least 2π phase coverage for the particular application in which the optical device 100 is to be implemented. In addition, it will be understood that the individual metaatoms 308 need not all have the same heights.

In this way, the disclosed multiband dichroic metamirror 102 can be flat while being able to split multiple wavebands 112, 114 into different paths and while providing optical power for one of the wavebands, such as by focusing or otherwise optically altering the second waveband 114. As a result, optical power can be provided without the need for coating a curved surface, which avoids the introduction of imaging complications that arise from a curved-surface dichroic.

Although FIG. 3 illustrate examples of details of a multiband dichroic metamirror 102, various changes may be made to FIG. 3. For instance, the multiband dichroic metamirror 102 may include additional components not shown in FIG. 3. In addition, note that the view shown in FIG. 3 is not necessarily to scale.

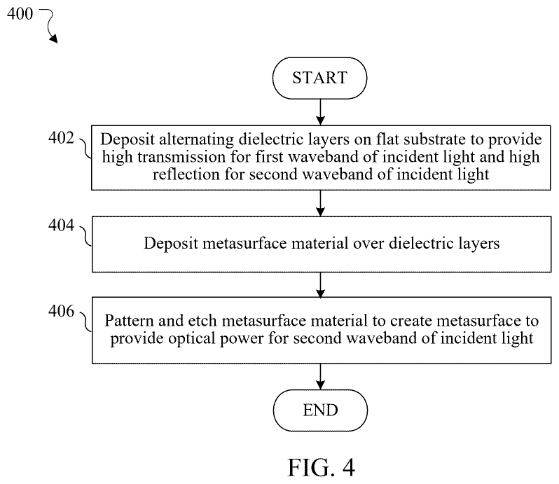

FIG. 4 illustrates an example of a method 400 for manufacturing the multiband dichroic metamirror 102 according to this disclosure. For ease of explanation, the method 400 is described as being used to form the multiband dichroic metamirror 102 shown in FIG. 3. However, the method 400 may be used to form any other suitable multiband dichroic metamirror designed in accordance with this disclosure.

As shown in FIG. 4, alternating dielectric layers 306 are deposited on a flat substrate 304 to provide high transmission for a first waveband 112 of incident light 110 and high reflection for a second waveband 114 of the incident light 110 at step 402. This may include, for example, depositing alternating thin films of titanium dioxide and silicon dioxide over a substrate 304. For another example, this may include depositing alternating thin films of other suitable dielectric materials, each having an index of refraction between 1.3 and 4.0, over a substrate 304. The substrate 304 may include sapphire, zinc selenide, zinc sulfide, calcium fluoride, barium fluoride, or other suitable substrate material(s) substantially transparent to the first waveband 112. In some cases, this may include the dielectric layers 306 being deposited over the substrate 304 using an ion beam sputtering process or other any suitable deposition process or other process. Also, in some embodiments, the first waveband 112 may include a MWIR band, and the second waveband 114 may include a SWIR band.

A metasurface material is deposited over the dielectric layers 306 at step 404. This may include, for example, depositing a uniform layer of amorphous silicon or other suitable metasurface material over the dielectric layers 306 by plasma-enhanced chemical vapor deposition or other suitable deposition technique or other process. The metasurface material is patterned and etched to create a metasurface 302 to provide optical power for the second waveband 114 of the incident light 110 at step 406. This may include, for example, patterning and etching the metasurface material to create the metasurface 302, which includes a plurality of metaatoms 308. The metasurface material may be patterned using photolithography or other patterning process. In some embodiments, the metasurface material may be about 525 nm thick such that the resulting metaatoms 308 may have a height of about 525 nm. In some embodiments, the metaatoms 308 may have a lattice constant of about 625 nm.

In some embodiments, the metasurface 302 acts as a diffractive optical element. Thus, the metasurface 302 may be configured to introduce an interference effect through the arrangement of the metaatoms 308. To accomplish this, patterning and etching the individual metaatoms 308 can be done in such a way as to implement different phase delays for the metaatoms 308. This results in a variable phase shift across the metasurface 302 for the second waveband 114 when the second waveband 114 passes through the metasurface 302 to reach the dielectric layers 306 and again when the second waveband 114 passes back through the metasurface 302 after being reflected from the dielectric layers 306. The variable phase shift allows the metaatoms 308 to provide a focusing function, an aberration correction, or other suitable optical function for the reflected second waveband 114. For example, in some embodiments, the second waveband 114 may be focused onto a second waveband image device 106 based on the arrangement of the metaatoms 308. Also, in some embodiments, in order to provide optical power for the second waveband 114, the metaatoms 308 may be configured to span at least a complete 2π phase shift at the wavelength of the second waveband 114. Thus, for embodiments in which the second waveband 114 includes SWIR, the metaatoms 308 may be formed such that the thickest and thinnest individual metaatoms 308 (which in some embodiments may include the absence of a metaatom 308) are configured to implement at least a 2π relative phase shift at wavelengths of about 1550 nm.

In some embodiments, the metaatoms 308 can be formed in the metasurface 302 with at least a portion of the metaatoms having non-identical shapes with respect to each other. Thus, for example, the metaatoms 308 may be rectangular in shape but may have individually varying widths. In other embodiments, the metaatoms 308 may include other suitable shapes but may have individually varying sizes and/or shapes. As described above, in some embodiments, the heights of the metaatoms 308 may be about 525 nm. However, it will be understood that the heights of the metaatoms 308 may be based on any suitable value that can provide at least 2π phase coverage. In addition, it will be understood that the individual metaatoms 308 need not all have the same heights.

Although FIG. 4 illustrates one example of a method 400 for manufacturing the multiband dichroic metamirror 102, various changes may be made to FIG. 4. For example, while shown as a series of steps, various steps in FIG. 4 may overlap, occur in parallel, occur in a different order, or occur any number of times (including zero times).

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A multiband dichroic metamirror comprising:
a dielectric mirror configured to split incident light into a first waveband and a second waveband, to transmit the first waveband with a high transmission value, and to reflect the second waveband with a high reflection value; and
a metasurface comprising a diffractive optical element configured to provide optical power for the second waveband.

2. The multiband dichroic metamirror of claim 1, wherein:
the first waveband comprises a Mid-Wave Infrared (MWIR) band; and
the second waveband comprises a Short-Wave Infrared (SWIR) band.

3. The multiband dichroic metamirror of claim 1, wherein:
the metasurface comprises a plurality of metaatoms;
at least a portion of the metaatoms comprise non-identical shapes with respect to each other; and
the metasurface is configured to provide optical power for the second waveband by introducing an interference effect through an arrangement of the metaatoms.

4. The multiband dichroic metamirror of claim 3, wherein the arrangement of the metaatoms is configured to implement a spatially varying phase delay between 0 and 2π for wavelengths associated with the second waveband.

5. The multiband dichroic metamirror of claim 1, wherein the optical power corresponds to a focusing function or an aberration correction.

6. The multiband dichroic metamirror of claim 1, wherein:
the dielectric mirror comprises a substrate and a plurality of dielectric layers;
the substrate comprises one of sapphire, zinc selenide, zinc sulfide, calcium fluoride or barium fluoride; and
the dielectric layers comprise alternating thin films of titanium dioxide and silicon dioxide.

7. The multiband dichroic metamirror of claim 1, wherein:
the metasurface comprises metaatoms with heights of about 525 nm and a lattice constant of about 625 nm.

8. The multiband dichroic metamirror of claim 1, wherein:
the dielectric mirror comprises a plurality of dielectric layers;
the dielectric layers comprise alternating thin films of different dielectric materials; and
each of the different dielectric materials has an index of refraction between 1.3 and 4.0.

9. An optical device comprising:
an aperture configured to receive incident light;
a multiband dichroic metamirror configured to split the incident light into a first waveband and a second waveband, to transmit the first waveband with a high transmission value, to reflect the second waveband with a high reflection value, and to provide optical power for the second waveband; and
a second waveband image device, wherein the multiband dichroic metamirror is further configured to direct the reflected second waveband towards the second waveband image device.

10. The optical device of claim 9, wherein the multiband dichroic metamirror comprises:
a dielectric mirror; and
a metasurface comprising a diffractive optical element configured to provide optical power for the second waveband.

11. The optical device of claim 10, wherein:
the metasurface comprises a plurality of metaatoms;
at least a portion of the metaatoms comprise non-identical shapes with respect to each other;
the metasurface is configured to provide optical power for the second waveband by introducing an interference effect through an arrangement of the metaatoms; and
the arrangement of the metaatoms is configured to implement a spatially varying phase delay between 0 and 2π for wavelengths associated with the second waveband.

12. The optical device of claim 10, wherein:
the dielectric mirror comprises a substrate and a plurality of dielectric layers;
the substrate comprises one of sapphire, zinc selenide, zinc sulfide, calcium fluoride or barium fluoride; and
the dielectric layers comprise alternating thin films of titanium dioxide and silicon dioxide.

13. The optical device of claim 10, wherein:
the metasurface comprises metaatoms with heights of about 525 nm and a lattice constant of about 625 nm.

14. The optical device of claim 10, wherein:
the dielectric mirror comprises a plurality of dielectric layers;
the dielectric layers comprise alternating thin films of different dielectric materials; and
each of the different dielectric materials has an index of refraction between 1.3 and 4.0.

15. The optical device of claim 9, wherein:
the first waveband comprises a Mid-Wave Infrared (MWIR) band; and
the second waveband comprises a Short-Wave Infrared (SWIR) band.

16. The optical device of claim 9, wherein the optical power corresponds to one of a focusing function or an aberration correction.

17. The optical device of claim 9, wherein the second waveband image device comprises at least one of a sensor, a transmitter, and a focal plane.

18. The optical device of claim 9, further comprising:
first waveband optics;
wherein the multiband dichroic metamirror is further configured to transmit the first waveband to the first waveband optics; and
wherein the first waveband optics comprise at least one lens and a focal plane.

19. A method comprising:
depositing a metasurface material over a dielectric mirror, wherein the dielectric mirror is configured to split incident light into a first waveband and a second waveband, to transmit the first waveband with a high transmission value, and to reflect the second waveband with a high reflection value; and
patterning and etching the metasurface material to create a metasurface configured to provide optical power for the second waveband.

20. The method of claim 19, wherein patterning and etching the metasurface material to create the metasurface comprises:
creating a plurality of metaatoms, wherein at least a portion of the metaatoms have non-identical shapes with respect to each other; and
arranging the plurality of metaatoms to implement a spatially varying phase delay between 0 and 2π for wavelengths associated with the second waveband.
